(19) United States
(12) Patent Application Publication
(10) Pub. No.: US 2024/0178407 A1
(43) Pub. Date: May 30, 2024

(54) MANUFACTURING METHOD OF SOLID OXIDE CELL

(71) Applicant: SAMSUNG ELECTRO-MECHANICS CO., LTD., Suwon-si (KR)

(72) Inventors: Jaeseok YI, Suwon-si (KR); Jung Deok PARK, Suwon-si (KR); Jeong Suong YANG, Suwon-si (KR); Hyeg Soon AN, Suwon-si (KR); Su Beom PARK, Suwon-si (KR); Jung Hyun LEE, Suwon-si (KR); Byung Chul JANG, Suwon-si (KR); Shiwoo LEE, Suwon-si (KR)

(73) Assignee: SAMSUNG ELECTRO-MECHANICS CO., LTD., Suwon-si (KR)

(21) Appl. No.: 18/215,937

(22) Filed: Jun. 29, 2023

(30) Foreign Application Priority Data
Nov. 30, 2022 (KR) 10-2022-0164767
Jan. 2, 2023 (KR) 10-2023-0000093

(51) Int. Cl. H01M 4/90; H01M 4/88; H01M 8/1213

(52) U.S. Cl. CPC H01M 4/9033; H01M 4/8825; H01M 8/1213; H01M 2008/1293

(57) ABSTRACT

A manufacturing method of a solid oxide cell including a fuel electrode, an air electrode and an electrolyte disposed therebetween is disclosed. Forming at least one of the fuel electrode and the air electrode, includes forming a first paste including electron conductor particles and a first solvent, forming a second paste including ion conductor particles and a second solvent, forming a paste for an electrode layer by mixing the first paste and the second paste, and sintering the paste for the electrode layer.

### CROSS-REFERENCE TO RELATED APPLICATION (S)

This application claims benefit of priority to Korean Patent Application Nos. 10-2022-0164767 filed on Nov. 30, 2022 and 10-2023-0000093 filed on Jan. 2, 2023, in the Korean Intellectual Property Office, the disclosures of which are incorporated herein by reference in its entirety.

### TECHNICAL FIELD

The present disclosure relates to a manufacturing method of a solid oxide cell.

A solid oxide fuel cell (SOFC) and a solid oxide electrolysis cell (SOEC) include a cell composed of a solid electrolyte having an air electrode, a fuel electrode, and oxygen ion conductivity, and the cell may be referred to as a solid oxide cell. A solid oxide cell produces electrical energy by electrochemical reactions, or produces hydrogen by electrolyzing water by reverse reactions of the solid oxide fuel cell. The solid oxide cell has low overvoltage based on low activation polarization and has high efficiency due to low irreversible loss as compared to other types of fuel cells or water electrolysis cells, such as a phosphoric acid fuel cell (PAFC), an alkaline fuel cell (AFC), a polymer electrolyte fuel cell (PEMFC), a direct methanol fuel cell (DMFC). Furthermore, because the solid oxide cell may not only be used for a hydrogen fuel but also for a carbon or hydrocarbon fuel, it can have a wide range of fuel choices, and because the solid oxide cell has a high reaction rate in an electrode, it does not require an expensive precious metal as an electrode catalyst.

An electrode layer of a solid oxide cell is generally manufactured by mixing electron conductor particles and ion conductor particles and has a porous three-dimensional shape. Here, when the electron conductor particles and the ion conductor particles are mixed, there is a need for a method of uniformly dispersing the particles.

### SUMMARY

An aspect of the present disclosure is to provide a manufacturing method of a solid oxide cell having improved characteristics of an electrode layer by improving dispersion of heterogeneous particles in manufacturing the electrode layer.

In order to solve the above-described issues, a manufacturing method of a solid oxide cell according to an aspect of the present disclosure is proposed, and there is provided the manufacturing method of a solid oxide cell including a fuel electrode, an air electrode and an electrolyte disposed therebetween. Forming at least one of the fuel electrode and the air electrode includes forming a first paste including electron conductor particles and a first solvent, forming a second paste including ion conductor particles and a second solvent, forming a paste for an electrode layer by mixing the first paste and the second paste, and sintering the paste for the electrode layer.

According to an example embodiment of the present disclosure, the forming the first paste includes a first dispersion operation of dispersing the electronic conductor particles into the first solvent, and the forming the second paste includes a second dispersion operation of dispersing the ion conductor particles in the second solvent.

According to an example embodiment of the present disclosure, the first and second dispersion operations are performed by different processes.

According to an example embodiment of the present disclosure, the first dispersion operation is performed using a three-roll mill.

According to an example embodiment of the present disclosure, the second dispersion operation is performed by at least one of a bead mill, a sand mill, and a basket mill.

According to an example embodiment of the present disclosure, the first paste has a higher viscosity than the second paste.

According to an example embodiment of the present disclosure, in the paste for the electrode layer, a weight ratio of the electron conductor particles to the ion conductor particles ranges from 3:7 to 7:3.

According to an example embodiment of the present disclosure, the fuel electrode is formed of the paste for the electrode layer, the electron conductor particles include at least one of Ni-based particles and lanthanum chromate-based (La₁₋ₓSrₓCrO₃, where 0≤x<1) particles, and the ion conductor particles include at least one of yttria stabilized zirconia (YSZ)-based particles, ceria (CeO₂)-based particles, bismuth oxide (Bi₂O₃)-based particles, and lanthanum gallate (LaGaO₃)-based particles.

According to an example embodiment of the present disclosure, the Ni-based particles include NiO particles.

According to an example embodiment of the present disclosure, the air electrode is formed of the paste for the electrode layer, the electronic conductor particles include at least one of lanthanum strontium manganite (LSM)-based particles, lanthanum strontium cobalt (LSC)-based particles, lanthanum strontium cobalt manganese (LSCM)-based particles, lanthanum strontium cobalt ferrite (LSCF)-based particles, lanthanum strontium ferrite (LSF)-based particles, barium strontium cobalt iron (BSCF)-based particles, and samarium strontium cobalt (SSC)-based particles, and the ion conductor particles include at least one of yttria stabilized zirconia (YSZ)-based particles, ceria (CeO₂)-based particles, bismuth oxide (Bi₂O₃)-based particles, and lanthanum gallate (LaGaO₃)-based particles.

According to an example embodiment of the present disclosure, the air electrode includes a functional layer, and the functional layer of the air electrode is formed of the paste for the electrode layer.

According to an example embodiment of the present disclosure, the forming at least one of the fuel electrode and the air electrode further includes applying the paste for the electrode layer to a green sheet for the electrolyte.

According to an example embodiment of the present disclosure, the forming at least one of the fuel electrode and the air electrode further includes a solvent substitution operation of substituting at least one of the first and second solvents before mixing the first and second pastes.

According to an example embodiment of the present disclosure, the electron conductor particles have a diameter greater than that of the ion conductor particles.

According to an example embodiment of the present disclosure, the first solvent includes ethyl cellulose dissolved in terpineol and mineral spirit, and the second solvent includes ethyl cellulose dissolved in toluene and ethanol.

According to an example embodiment of the present disclosure, a weight ratio of ethyl cellulose:terpineol:mineral spirit is (5% to 15%):(70% to 80%):(10% to 30%), and a weight ratio of ethyl cellulose:toluene:ethanol is (10% to 15%):(20% to 40%):(45% to 70%).

A manufacturing method of a solid oxide cell according to an example embodiment of the present invention may improve the dispersion of heterogeneous particles when manufacturing an electrode layer. When the solid oxide cell obtained by the manufacturing method is used as a fuel cell or a water electrolytic cell, performance thereof may be improved.

### BRIEF DESCRIPTION OF DRAWINGS

The above and other aspects, features, and advantages of the present disclosure will be more clearly understood from the following detailed in description, taken conjunction with the accompanying drawings, in which:

FIG. 1 is a cross-sectional view schematically illustrating a solid oxide cell which may be obtained by a manufacturing method of a solid oxide cell according to an example embodiment of the present disclosure;

FIG. 2 is an enlarged view of a region (i.e., region A) of the solid oxide cell of FIG. 1;

FIG. 3 is an enlarged view of a region (i.e., region B) of the solid oxide cell of FIG. 1;

FIG. 4 is a flowchart illustrating a manufacturing method of a solid oxide cell according to an example embodiment of the present disclosure;

FIG. 5 is a view illustrating a process of mixing a first paste and a second paste;

FIG. 6 is a view illustrating an example of a paste for an electrode layer that may be obtained by applying a dispersion process according to an example embodiment of the present disclosure;

FIG. 7 is a view illustrating an example of a paste for an electrode layer that may be obtained by applying a conventional dispersion process;

FIG. 8 is a flowchart illustrating a manufacturing method of a solid oxide cell according to a modified example;

FIG. 9 is a view illustrating an example of a process of applying a paste for an electrode layer on a green sheet for an electrolyte;

FIG. 10 is a cross-sectional view schematically illustrating another type of solid oxide cell that may be obtained by the manufacturing method of a solid oxide cell according to an example embodiment of the present disclosure; and

FIG. 11 is a cross-sectional view schematically illustrating another type of solid oxide cell which may be obtained by the method for manufacturing a solid oxide cell according to an example embodiment of the present disclosure.

### DETAILED DESCRIPTION

Hereinafter, example embodiments of the present disclosure will be described with reference to specific example embodiments and the attached drawings. The example embodiments of the present disclosure may, however, be exemplified in many different forms and should not be construed as being limited to the specific embodiments set forth herein. The example embodiments disclosed herein are provided for those skilled in the art to better explain the present disclosure. In the drawings, the shapes and dimensions of elements may be exaggerated for clarity, and the same reference numerals will be used throughout to designate the same or like elements.

In order to clearly explain the present disclosure in the drawings, the contents unrelated to the description are omitted, thicknesses of each component are enlarged to clearly express multiple layers and regions, and components with the same function within the same range of ideas are described using the same reference numerals. Throughout the specification, when a certain portion “includes” or “comprises” a certain component, this indicates that other components are not excluded and may be further included unless otherwise noted.

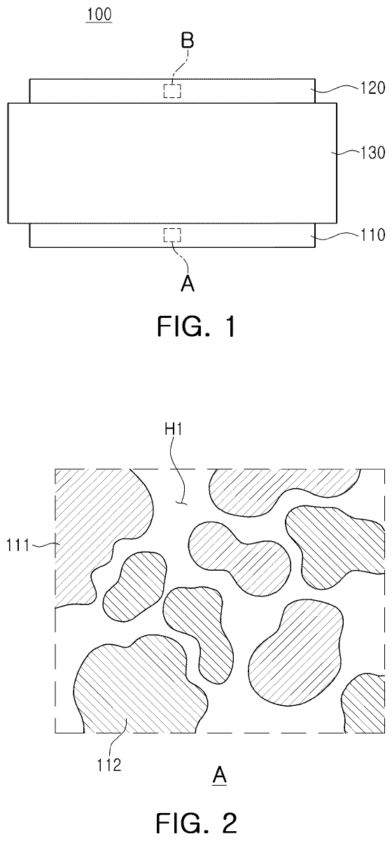

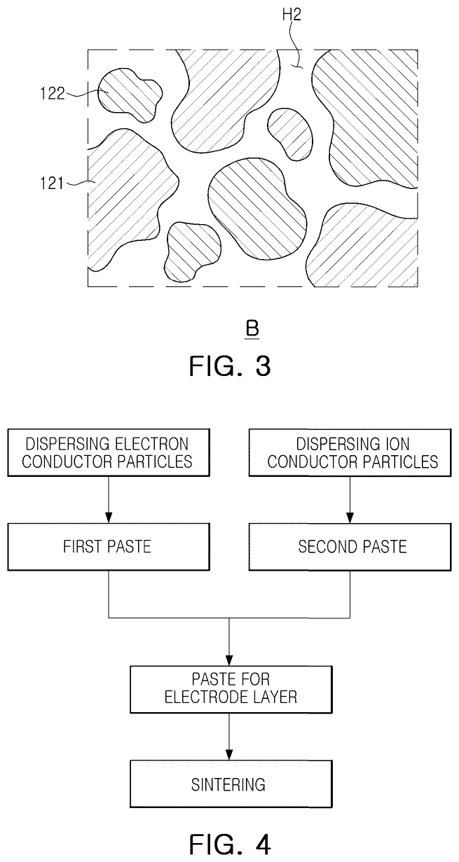

FIG. 1 is a cross-sectional view schematically illustrating a solid oxide cell which may be obtained by a manufacturing method of a solid oxide cell according to an example embodiment of the present disclosure. FIGS. 2 and 3 are enlarged views of each of regions A and B of the solid oxide cell of FIG. 1. FIG. 4 is a flowchart illustrating a manufacturing method of a solid oxide cell according to an example embodiment of the present disclosure.

A solid oxide cell 100 may include a first electrode layer 110, an air electrode 120, and an electrolyte 130 placed therebetween, as major components, and the solid oxide cell 100 may be obtained using a manufacturing method of a solid oxide cell according to an example embodiment of the present disclosure. Specifically, for the manufacturing method of a solid oxide cell according to this example embodiment, as described in FIG. 4, forming at least one of the fuel electrode 110 and the air electrode 120 includes forming a first paste including electron conductor particles and a first solvent, forming a second paste including ion conductor particles and a second solvent, forming a paste for an electrode layer by mixing the first paste and the second paste, and sintering the paste for the electrode layer.

In an example embodiment of the present disclosure, a paste for an electrode layer may be produced by dispersing electron conductor particles and ion conductor particles in separate processes and then mixing the electron conductor particles and the ion conductor particles, and accordingly, a dispersion process suitable for characteristics of each particle may be applied thereto. The paste for an electrode layer obtained in this manner has a high degree of dispersion even though it includes heterogeneous particles, and in the case of the solid oxide cell 100 including an electrode layer formed using the paste, high efficiency may be achieved as a reaction region of an entire electrode layer becomes uniform. Hereinafter, the components of the solid oxide cell 100 and a manufacturing method thereof are specifically described, and the solid oxide cell 100 may be used as a fuel cell or a water electrolysis cell. When the solid oxide cell 100 is the water electrolysis cell, a reaction opposite to a case of the fuel cell will occur in the fuel electrode 110 and the air electrode 120.

The fuel electrode 110 and the air electrode 120 correspond to an electrode layer in which a major reaction occurs in the solid oxide cell 100. Specifically, when the solid oxide cell 100 is the fuel cell, for example, water production due to hydrogen oxidation or an oxidation reaction of a carbon compound may occur in the fuel electrode 110, and an oxygen ion generation reaction may occur depending on oxygen decomposition in the air electrode 120. In the case of the water electrolytic cell, a reaction opposite to the case of the fuel electrode may occur, for example, hydrogen gas may be generated according to a reduction reaction of water in the fuel electrode 110, and oxygen may be generated in the air electrode 120. Furthermore, as another example, in the case of the fuel cell, a hydrogen decomposition (hydrogen ion generation) reaction may occur in the fuel electrode 110, and oxygen and hydrogen ions may be combined to generate water in the air electrode 120, and in the case of the water electrolysis cell, a water decomposition (hydrogen and oxygen ion generation) reaction may occur in the fuel electrode 110, and oxygen may be generated in the air electrode 120. As illustrated in FIG. 2, the fuel electrode 110 may include an electron conductor 111 and an ion conductor 112 which may be a sintered body of particles. Here, the electronic conductor 111 of the fuel electrode 110 may perform electrical conduction and catalyst functions, and may include, for example, a Ni-based material and a lanthanum chromate-based (La₁₋ₓSrₓCrO₃, where 0≤x<1) material. Furthermore, the ion conductor 112 of the fuel electrode 110 may include an yttria stabilized zirconia (YSZ)-based material, a ceria (CeO₂)-based material, a bismuth oxide (Bi₂O₃)-based material, and a lanthanum gallate (LaGaO₃)-based material. Furthermore, the fuel electrode 110 may be a porous body including pores H1, and gases, fluids, and the like, may enter and exit through the pores H1.

As illustrated in FIG. 3, the air electrode 120 may include an electron conductor 121 and an ion conductor 122, which may be a sintered body of particles. In the air electrode 120, the electronic conductor 121 may a lanthanum strontium manganite (LSM)-based material, a lanthanum strontium cobalt (LSC)-based material, a lanthanum strontium cobalt manganese (LSCM)-based material, a lanthanum strontium cobalt ferrite (LSCF)-based material, a lanthanum strontium ferrite (LSF)-based material, a barium strontium cobalt iron (BSCF)-based material, and a samarium strontium cobalt (SSC)-based material. The ion conductor 122 may include an yttria stabilized zirconia (YSZ)-based material, a ceria (CeO₂)-based material, a bismuth oxide (Bi₂O₃)-based material, and a lanthanum gallate (LaGaO₃)-based material. Furthermore, the air electrode 120 may be a porous body including pores H2, and gases, fluids, and the like, may enter and exit through the pores H2.

The electrolyte 130 may be disposed between the fuel electrode 110 and the air electrode 120, and ions may move to the fuel electrode 110 or the air electrode 120. As an example of the material constituting the electrolyte 130, a material constituting the ion conductors 112 and 122 of the fuel electrode 110 and the air electrode 120 may be used. As a representative example, the electrolyte 130 may include stabilized zirconia. Specifically, the electrolyte 130 may include scandia stabilized zirconia (SSZ), yttria stabilized zirconia (YSZ), scandia ceria stabilized zirconia (SCSZ), scandia ceria yttria stabilized zirconia (SCYSZ), and scandia ceria ytterbia stabilized zirconia (SCYbSZ).

At least one of the fuel electrode 110 and the air electrode 120 may be obtained by a method of dispersing and mixing electron conductor particles and ion conductor particles in a separate dispersion process as described above, and in an example embodiment of the present disclosure, it will be described based on a manufacturing method of a fuel electrode 110. However, the air electrode 120 may also be formed by such a separate dispersion process.

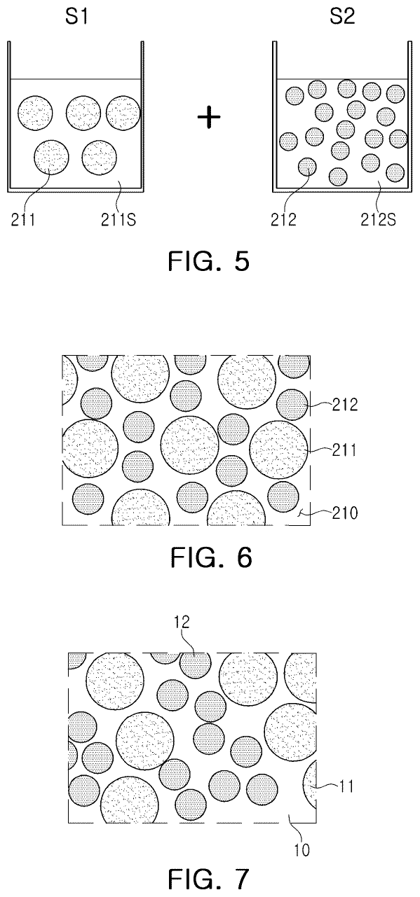

Referring to FIGS. 4 and 5, an operation of forming the fuel electrode 110 includes an operation of forming a first paste S1 and an operation of forming a second paste S2, and then includes an operation of forming a paste for an electrode layer by mixing the first paste S1 and the second paste S2. The first paste S1 includes electron conductor particles 211 and a first solvent 211S. The electron conductor particles 211 correspond to a raw material for forming the electron conductor 111 of the fuel electrode 110 after a sintering operation described below. The electron conductor particles 211 may include at least one of Ni-based particles and lanthanum chromate (La₁₋ₓSrₓCrO₃, where 0≤x<1)-based particles. When the electron conductor particles 211 are the Ni-based particles, they may be NiO particles. The first paste S1 may further include a dispersant in addition to the electron conductor particles 211 and the first solvent 211S. The second paste S2 includes ion conductor particles 212 and a second solvent 212S. The ion conductor particles 212 correspond to a raw material for forming the ion conductor 112 of the fuel electrode 110. The ion conductor particles 212 may include at least one of yttria stabilized zirconia (YSZ)-based particles, ceria (CeO₂)-based particles, bismuth oxide (Bi₂O₃)-based particles, and lanthanum gallate (LaGaO₃)-based particles. The second paste S2 may further include a dispersant in addition to the electron conductor particles 212 and the second solvent 212S. A ratio of the electron conductor particles 211 to the ion conductor particles 212 may be adopted as a condition for functioning as an electrode layer, and, for example, may range from 3:7 to 7:3 based on the weight ratio. Furthermore, as illustrated, the electron conductor particles 211 may have a larger diameter than the ion conductor particles 212.

In an example embodiment of the present disclosure, the electron conductor particles 211 and the ion conductor particles 212 need to be dispersed in separate processes so as to apply an optimal dispersion process according to the characteristics of each particle because the electron conductor particles 211 and the ion conductor particles 212 have different materials, sizes, shapes, and surface characteristics. Specifically, the operation of forming the first paste S1 including the electron conductor particles 211 may include a first dispersion operation of dispersing the electron conductor particles 211 into the first solvent 211S. The electron conductor particles 211 in the first paste S1 may have relatively high viscosity and may be dispersed using, for example, a three-roll mill by means of a method of dispersing a high viscosity paste including particles such as a metal. In this case, the viscosity of the first paste S1 may be 100,000 cps or more. In the high viscosity dispersion process, the particles may be uniformly dispersed by applying shear stress that gets stronger on a dispersant as a viscosity increases, but when the viscosity are too high, the dispersant may not escape from a dispersion facility. The first solvent 211S may be a fluid that imparts fluidity to the electron conductor particles 211, and may further include a binder. In the case of the first solvent 211S, ethyl cellulose dissolved in terpineol and mineral spirit may be used, and for example, ethyl cellulose:terpineol:mineral spirit may be mixed in a weight ratio of (5% to 15%):(70% to 80%):(10% to 30%). Furthermore, in the case of a dispersant that may be included in the first paste S1, an anionic dispersant may be used. Examples of the anionic dispersant include a dispersant having a functional group such as a phosphoric acid group or a sulfonic acid group.

The operation of forming the second paste S2 may include a second dispersion operation of dispersing the ion conductor particles 212 into the second solvent 212S. For the second paste S2, a viscosity thereof may be lower than that of the first paste S1, for example, the viscosity thereof may be 1,000 cps or less. The ion conductor particles 212 may be dispersed through a low viscosity dispersion process in the second paste S2 having a relatively low viscosity. As described above, the first and second dispersion operations may be performed by different processes. Specifically, a dispersion process (i.e., a second dispersion operation) of the second paste S2 is a process suitable for low viscosity dispersion and may be performed by at least one of a bead mill, a sand mill, and a basket mill. The second solvent 212S may be a fluid that imparts fluidity to the ion conductor particles 212 and may further include a binder. For the second solvent 212S, ethyl cellulose dissolved in toluene and ethanol may be used, and in this case, ethyl cellulose:toluene:ethanol may have a weight ratio of (10% to 15%):(20% to 40%):(45% to 70%), and based on the weight ratio thereof, the ethyl cellulose may be dissolved and used in the toluene and the ethanol. Furthermore, in the case of a dispersant that may be included in the second paste S2, an anionic dispersant may be used. Examples of the anionic dispersant may include a dispersant having a functional group such as a phosphoric acid group or a sulfonic acid group.

Then, the first paste S1 and the second paste S2 are mixed to form a paste for an electrode layer. Here, for a method of mixing the pastes S1 and S2, for example, a planetary mixer, a revolution mixer, and a resonant acoustic mixer may be used. As described above, the first paste S1 and the second paste S2 may independently be subject to separate dispersion processes suitable for particles having different characteristics, and dispersibility may be greatly improved when the pastes S1 and S2 are mixed with each other. FIG. 6 is a view illustrating a paste for an electrode layer obtained by the manufacturing method according to an example embodiment of the present disclosure, and the electron conductor particles 211 and the ion conductor particles 212 are uniformly mixed in a mixed solvent 210.

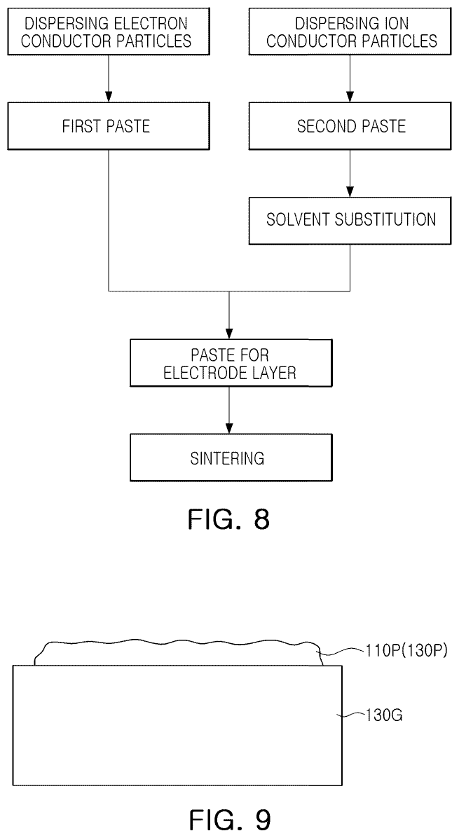

In comparison therewith, in the case of conventional technology, electron conductor particles 11 and ion conductor particles 12 are mixed at once and dispersed, that is, executed in a single dispersion process, and as illustrated in FIG. 7, the degree of dispersion of the electron conductor particles 11 and the ion conductor particles 12 is relatively low in a solvent 10. On the other hand, as in a modified example of FIG. 8, the manufacturing method may further include a solvent substitution operation of substituting at least one portion of the first solvent 211S and the second solvent 212S before mixing the first paste S1 and the second paste S2, and FIG. 9 is a view illustrating an example in which the solvent substitution operation is applied to the second paste S2. Here, the substitution includes removing at least a portion of the solvents 211S and 212S, and changing at least a portion of the solvents 211S and 212S to another solvent. By the solvent substitution operation, the solvents 211S and 212S of the first paste S1 and the second paste S1 may be made similar or substantially identical to each other, from which the first paste S1 and the second paste S1 may be effectively mixed. In this case, solvent substitution may be performed through, for example, decompression distillation, filtration, centrifugation, or the like.

Referring to FIG. 9, a next process will be described, and a paste 110P for an electrode layer obtained by the above-described method may be applied to a green sheet 130G for an electrolyte and may be then formed into a fuel electrode 110 through a sintering operation. In this manner, an electrolyte 130 supporting type solid oxide cell 100 may be implemented. In an example embodiment of the present disclosure, a method in which the fuel electrode 110 is formed of the paste 110P for an electrode layer was described, but in addition to the fuel electrode 110, the air electrode 130 may also be formed of particles 121 and 122 having high dispersibility through the above-described separate dispersion process. In this case, in a paste 130P for forming the air electrode 130, the electron conductor particles 211 may include at least one of lanthanum strontium manganite (LSM)-based particles, lanthanum strontium cobalt (LSC)-based particles, lanthanum strontium cobalt manganese (LSCM)-based particles, lanthanum strontium cobalt ferrite (LSCF)-based particles, lanthanum strontium ferrite (LSF)-based particles, barium strontium cobalt iron (BSCF)-based particles, and samadium strontium cobalt (SSC)-based particles. The ion conductor particles 212 may include yttria stabilized zirconia (YSZ)-based particles, ceria (CeO₂)-based particles, bismuth oxide (Bi₂O₃)-based particles, and lanthanum gallate (LaGaO₃)-based particles.

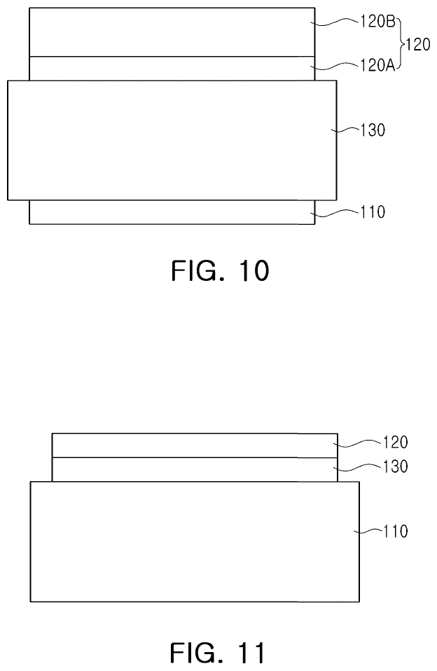

Another type of solid oxide cell that may be obtained by the manufacturing method of a solid oxide cell described above will be described with reference to FIGS. 10 and 11. First of all, for an example embodiment of FIG. 10, the air electrode 120 includes an electrode layer 120B and a functional layer 120A, where the functional layer 120A is disposed adjacent to the electrolyte 130. When the separate dispersion process described above is applied to the air electrode 120, it may be applied to the functional layer 120A of the air electrode 120, and in this case, the reaction efficiency may be improved by uniformizing the shape of pores and materials constituting the functional layer 120A in which most of reactions occur. Furthermore, an example embodiment of FIG. 11 corresponds to a solid oxide cell of a fuel electrode-supporting type. The fuel electrode 110 may be the thickest, and a solid oxide cell may be implemented by sequentially forming the electrolyte 130 and the air electrode 120 on the fuel electrode 110. The above-described manufacturing method may also be applied to a cell of a solid oxide of a fuel electrode-supporting type as illustrated in FIG. 11, and for example, the air electrode 130 may be formed using the paste for the electrode layer obtained by the above-described separate dispersion process.

The present disclosure is not limited to the above-described example embodiments and the accompanying drawings but is defined by the appended claims. Therefore, those of ordinary skill in the art may make various replacements, modifications, or changes without departing from the scope of the present disclosure defined by the appended claims, and these replacements, modifications, or changes should be construed as being included in the scope of the present disclosure.

What is claimed is:

1. A manufacturing method of a solid oxide cell including a fuel electrode, an air electrode and an electrolyte disposed between the fuel electrode and the air electrode, wherein forming at least one of the fuel electrode and the air electrode, comprises:
forming a first paste including electron conductor particles and a first solvent;
forming a second paste including ion conductor particles and a second solvent;
forming a paste for an electrode layer by mixing the first paste and the second paste; and
sintering the paste for the electrode layer.

2. The manufacturing method according to claim 1, wherein the forming the first paste includes a first dispersion operation of dispersing the electronic conductor particles into the first solvent, and
the forming the second paste includes a second dispersion operation of dispersing the ion conductor particles in the second solvent.

3. The manufacturing method according to claim 2, wherein the first and second dispersion operations are performed by different processes.

4. The manufacturing method according to claim 3, wherein the first dispersion operation is performed using a three-roll mill.

5. The manufacturing method according to claim 3, wherein the second dispersion operation is performed by at least one of a bead mill, a sand mill, and a basket mill.

6. The manufacturing method according to claim 1, wherein the first paste has a higher viscosity than the second paste.

7. The manufacturing method according to claim 1, wherein in the paste for the electrode layer, a weight ratio of the electron conductor particles to the ion conductor particles ranges from 3:7 to 7:3.

8. The manufacturing method according to claim 1, wherein the fuel electrode is formed of the paste for the electrode layer,
the electron conductor particles include at least one of Ni-based particles and lanthanum chromate (La₁₋ₓSrₓCrO₃, where 0≤x<1)-based particles, and
the ion conductor particles include at least one of yttria stabilized zirconia (YSZ)-based particles, ceria (CeO₂)-based particles, bismuth oxide (Bi₂O₃)-based particles, and lanthanum gallate (LaGaO₃)-based particles.

9. The manufacturing method according to claim 8, wherein the Ni-based particles include NiO particles.

10. The manufacturing method according to claim 1, wherein the air electrode is formed of the paste for the electrode layer,
the electronic conductor particles include at least one of lanthanum strontium manganite (LSM)-based particles, lanthanum strontium cobalt (LSC)-based particles, lanthanum strontium cobalt manganese (LSCM)-based particles, lanthanum strontium cobalt ferrite (LSCF)-based particles, lanthanum strontium ferrite (LSF)-based particles, barium strontium cobalt iron (BSCF)-based particles, and samarium strontium cobalt (SSC)-based particles, and
the ion conductor particles include at least one of yttria stabilized zirconia (YSZ)-based particles, ceria (CeO₂)-based particles, bismuth oxide (Bi₂O₃)-based particles, and lanthanum gallate (LaGaO₃)-based particles.

11. The manufacturing method according to claim 1, wherein the air electrode includes a functional layer, and the functional layer of the air electrode is formed of the paste for the electrode layer.

12. The manufacturing method according to claim 1, wherein the forming at least one of the fuel electrode and the air electrode, further comprises:
applying the paste for the electrode layer to a green sheet for the electrolyte.

13. The manufacturing method according to claim 1, wherein the forming at least one of the fuel electrode and the air electrode, further comprises:
a solvent substitution operation of substituting at least one of the first and second solvents before mixing the first and second pastes.

14. The manufacturing method according to claim 1, wherein the electron conductor particles have a diameter greater than that of the ion conductor particles.

15. The manufacturing method according to claim 1, wherein the first solvent includes ethyl cellulose dissolved in terpineol and mineral spirit, and
the second solvent includes ethyl cellulose dissolved in toluene and ethanol.

16. The manufacturing method according to claim 15, wherein a weight ratio of ethyl cellulose:terpineol:mineral spirit is (5% to 15%):(70% to 80%):(10% to 30%), and
a weight ratio of ethyl cellulose:toluene:ethanol is (10% to 15%):(20% to 40%):(45% to 70%).
